(19) United States
(12) Patent Application Publication
(10) Pub. No.: US 2012/0173205 A1
(43) Pub. Date: Jul. 5, 2012

(54) SYSTEM AND METHOD FOR FORMING 3D MODEL OF EJECTOR PIN OF MOLD

(75) Inventors: YUN-LUNG CHEN, Tu-Cheng (TW); MING-FA ZHANG, Tu-Cheng (TW); CHUAN-KAI CHANG, Tu-Cheng (TW)

(73) Assignee: HON HAI PRECISION INDUSTRY CO., LTD., Tu-Cheng (TW)

(21) Appl. No.: 13/188,074

(22) Filed: Jul. 21, 2011

(30) Foreign Application Priority Data
Dec. 29, 2010 (CN) 201010612600.5

(51) Int. Cl. G06F 17/50

(52) U.S. Cl. 703/1

(57) ABSTRACT

A system for forming a 3D model of ejector pins for a mold includes a 2D model drawing unit, an ejector pin parameter obtaining unit, and a 3D model drawing unit. The 2D model drawing unit opens a mold 2D model which includes a plurality of ejector pins. The ejector pin parameter obtaining unit obtains parameters of the plurality of ejector pins in the mold 2D model. The 3D model drawing unit automatically forms corresponding ejector pin 3D model according to the parameters obtained by the ejector pin parameter obtaining unit.

### BACKGROUND

1. Technical Field

The present disclosure relates to mold design systems and methods, and more particularly to a method and system for forming a 3D model of ejector pins for a mold.

2. Description of Related Art

Molds (including injection molds and punching modules) are well-known devices which may be used for the fabrication of complex shaped plastic or metal objects or parts. During molding, raw molten material is processed in a corresponding mold to be formed into the required shape. Once the molten material (typically plastic or metal) is set or cured, the mold is opened, and ejector pins of the mold push molded object out of the mold. Usually, the mold is equipped with a plurality of ejector pins, which can push different portions of the molded object, to protect the molded object from damage. Therefore, the ejector pins and their design can be very important. A conventional design method is first to draw a 2D model of the ejector pins, and then draw a 3D model of the ejectors pins with the designer using the dimensions of the 2D model. However, this method can be tedious because there are many dimensions that need to be considered.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an exemplary embodiment of a system for forming a 3D model of ejector pins of a mold.

FIG. 2 is a flow diagram of an exemplary embodiment of a method for forming a 3D model of ejector pins of a mold.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

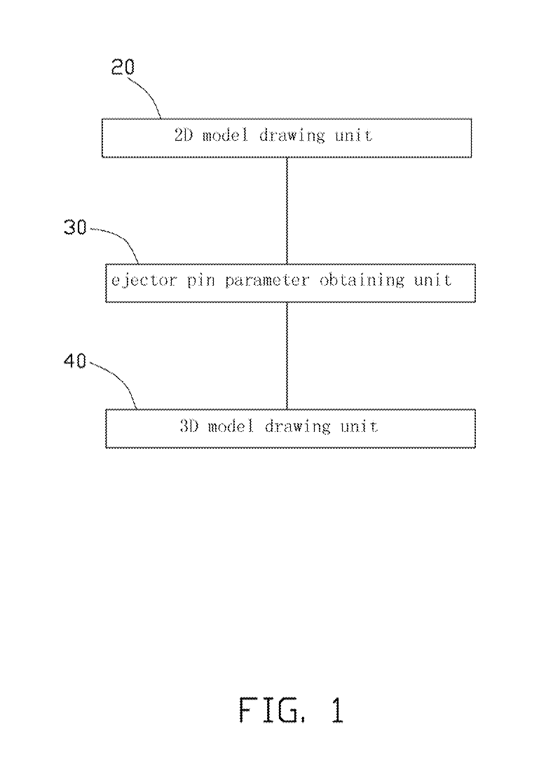

Referring to FIG. 1, a system for forming a 3D model of ejector pins of a mold includes a 2D model drawing unit 20, an ejector pin parameter obtaining unit 30, and a 3D model drawing unit 40. In one embodiment, the 2D model drawing unit 20 is AutoCAD, software which is developed by Autodesk company. The 3D model drawing unit 30 is Pro/Engineer, software which is developed by Parametric Technology Corporation.

The 2D model drawing unit 20 opens an mold 2D model, which includes a plurality of ejector pins.

The ejector pin parameter obtaining unit 30 processes the mold 2D model, and obtains parameters of the ejector pins in the mold 2D model. The parameters of the ejector pins include dimensions of each ejector pin, location of each ejector pin, and shape of each ejector pin.

The 3D model drawing unit 40 draws corresponding ejector pin 3D model according to the parameters obtained by the ejector pin parameter obtaining unit 30.

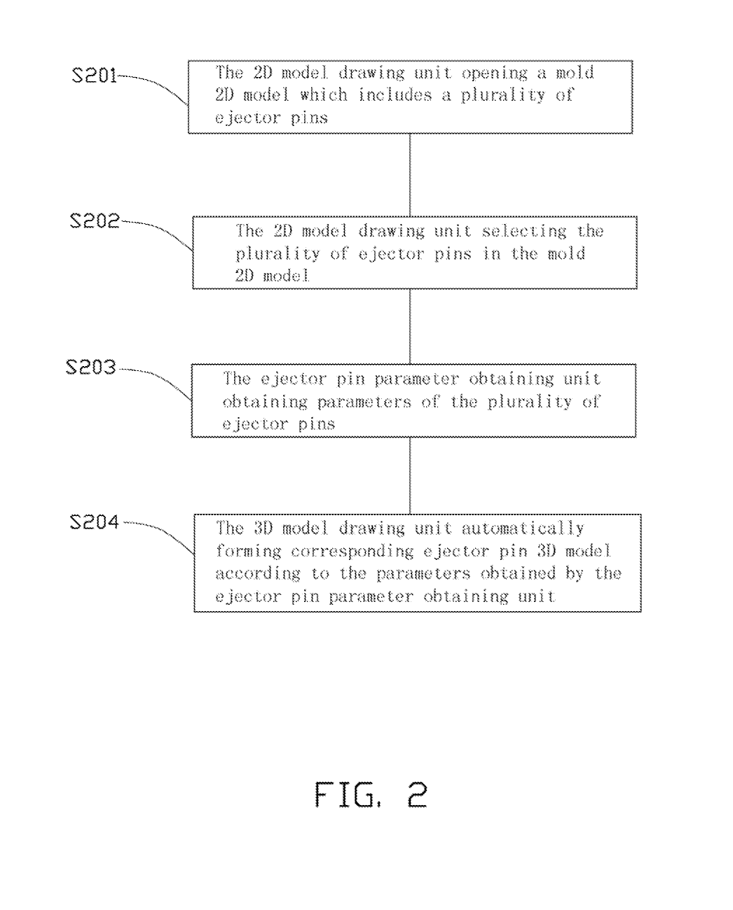

Referring to FIG. 2, a method for forming a 3D model of ejector pins of a mold includes following steps.

In step S201, the 2D model drawing unit 20 opens a 2D model of a mold which includes a plurality of ejector pins.

In step S202, the 2D model drawing unit 20 selects the plurality of ejector pins in the 2D model of the mold.

In step S203, the ejector pin parameter obtaining unit 30 obtains parameters of the plurality of ejector pins. The parameters of the plurality of ejector pins include dimensions of each ejector pin, location of each ejector pin, and the shape of each ejector pin.

In step S204, the 3D model drawing unit 40 automatically forms corresponding ejector pin 3D model according to the parameters obtained by the ejector pin parameter obtaining unit 30.

The system and method for forming a 3D model of ejector pins for a mold that can automatically draw a 3D model of the ejector pins. Therefore, when the 3D model of ejector pins needs to be modified, only the corresponding 2D model of the mold needs to be modified, which can be convenient.

It is to be understood, however, that even though numerous characteristics and advantages of the embodiments have been set forth in the foregoing description, together with details of the structure and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A system for forming a 3D model of ejector pins of a mold, comprising:
a 2D model drawing unit adapted to open a mold 2D model, the mold 2D model including a plurality of ejector pins;
an ejector pin parameter obtaining unit adapted to obtain parameters of the plurality of ejector pins in the mold 2D model; and
a 3D model drawing unit adapted to automatically form corresponding ejector pin 3D models according to the parameters obtained by the ejector pin parameter obtaining unit.

2. The system of claim 1, wherein the parameters comprise dimensions of each of the plurality of ejector pins.

3. The system of claim 2, wherein the parameters further comprise a location of each of the plurality of ejector pins.

4. The system of claim 3, wherein the parameters further comprise a shape of each of the plurality of ejector pins.

5. A method for forming a 3D model of ejector pins of a mold, comprising:
opening a mold 2D model, the mold 2D model including a plurality of ejector pins;
obtaining parameters of the plurality of ejector pins in the mold 2D model; and
forming corresponding ejector pin 3D model according to the parameters.

6. The system of claim 5, wherein the parameters comprise dimensions of each of the plurality of ejector pins.

7. The system of claim 6, wherein the parameters further comprise a location of each of the plurality of ejector pins.

8. The system of claim 7, wherein the parameters further comprise a shape of each of the plurality of ejector pins.

9. A method for forming a 3D model of ejector pins of a mold, comprising:
providing a 2D model drawing unit, an ejector pin parameter obtaining unit, and a 3D model drawing unit;
opening a mold 2D model, which includes a plurality of ejector pins, by the 2D model drawing unit;
obtaining parameters of the plurality of ejector pins in the mold 2D model by the ejector pin parameter obtaining unit; and
forming corresponding ejector pin 3D model according to the parameters by the 3D model drawing unit.
